(19) United States
(12) Patent Application Publication
(10) Pub. No.: US 2015/0203017 A1
(43) Pub. Date: Jul. 23, 2015

(54) DEVICE FOR THE ENTRY AND EXIT OF MOTORCICLE WITH TWO OR MORE WHEELS

(71) Applicant: Domenico TRABUIO, (US)

(72) Inventor: Domenico Trabuio, Casale Sul Sile (IT)

(73) Assignee: Domenico TRABUIO, Casale Sul Sile, TV (IT)

(21) Appl. No.: 13/261,994

(22) PCT Filed: Jan. 9, 2013
(86) PCT No.: PCT/IT13/00008

§ 371 Date: Nov. 24, 2014

(30) Foreign Application Priority Data
Jan. 12, 2012 (IT) TV2012A000004

(51) Int. Cl. B60P 1/00; B60P 3/075

(52) U.S. Cl. CPC B60P 1/00; B60P 3/075

(57) ABSTRACT

A device which allows motorcycles fitted with two or more wheels to easily enter and exit any larger vehicle within which they are transported. The device can be used on camper vans, trucks, vans and so on. It is an entirely mechanical system consisting in a rail (1) and an engine (2) which will facilitate the entry and exit of motorcycles from any dedicated motor vehicle.

The invention consists of a device (table 1) which allows motorcycles with two or more wheels to easily enter and exit any larger vehicle within which they are transported.

The device can be used on camper vans, trucks, vans and so on. It is an entirely mechanical system consisting of metal rail and an engine which will facilitate the loading and unloading of motorcycles into and out of any other vehicle within which they are transported.

### DESCRIPTION OF RELATED ART

The only known patent in prior art is U.S. Pat. No. 5,649,803 assigned to Mr. Gary R. Bennett from Tulsa, Oklahoma, registered on Jul. 22, 1997. Said patent works with a gear rack; it is heavy and not flexible, unlike our device that uses a belt or chain.

There exist other ways of loading and unloading motorcycles inside garages, camper vans or onto vehicles within which they are transported. These systems are manual, mechanical or electrical:
Manual ramp for loading vehicles with the help of two or more people. One person pushes the vehicle from the outside and keeps it steady while the other drives the vehicle itself;
Carriage fixed onto the front wheel of the motorcycle and pushed along a ramp which guides the carriage itself into the camper storage area or inside the truck.
Manually operated system employing more than one person. The loading ramp is fitted onto rails with bearings. Once the front wheel of the vehicle has reached the inside of the camper van or truck, it is pulled in by a person situated inside, while at the same time being pushed by a person outside.
System which uses an electric winch and harnesses the front part or the handlebars of the motorcycle, procedure that may damage or dent the bodywork. The motorcycle is then pulled up the ramp inside the camper van or truck. This system is also only employed for loading vehicles onto trucks and camper vans, and cannot be used for unloading purposes.
System with rails mounted onto a loading ramp along which motorcycles are pulled up by means of an electric winch and by fixing the tow cable onto the handlebars of the motorcycle itself.
System with guide rails for a hoisting ramp fitted onto a gear rack. Said system is driven by an electric engine which hoists and lowers the upright motorcycle outside the camper van until it is well inside the van.

The above systems are rather complicated and laborious as they require more people to assist with the loading of motorcycles; some of them can also damage or break parts of the motorcycle since the harness is placed directly onto bodywork or handlebars, and can be dangerous for the user.

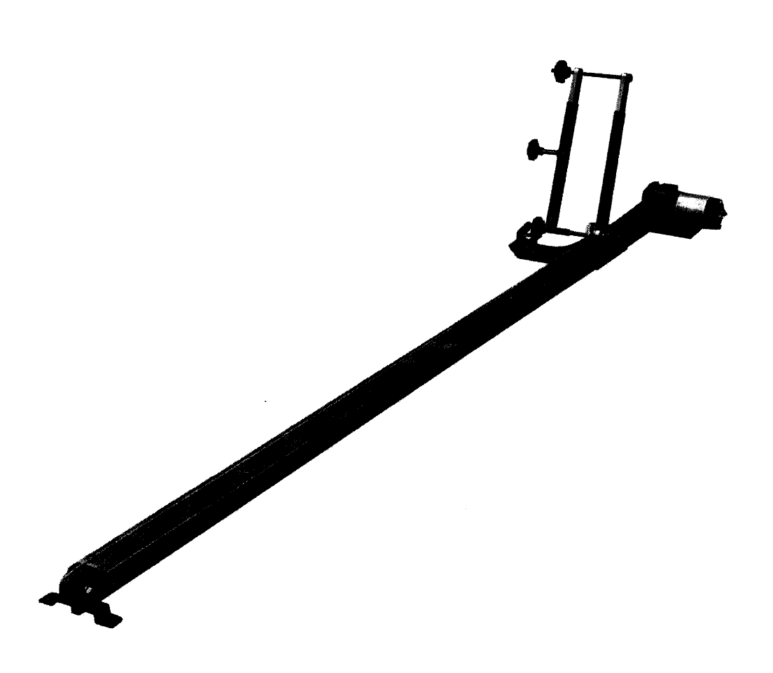

The invention herein presented fulfills the ergonomic, economic and market requirements and avoids the drawbacks illustrated above (FIG. 1).

The invention can be used for camper vans, trucks, and any other vehicle therefore it neither has any weight or size limitations nor does it present any of the safety issues of the existing manual and electrically operated devices. Since it can be used on any type of camper van and truck, it also avoids issues linked to both storage of motorcycles and production of certain standard sizes of camper vans and trucks.

### BRIEF DESCRIPTION OF THE DRAWINGS

The characteristics of the invention herein presented are clarified in the following description that provides a non-exhaustive example with reference to the attached drawings:

Table 1 illustrates the device in its entirety

Table 2 illustrates the main parts of the device

### TECHNICAL DESCRIPTION

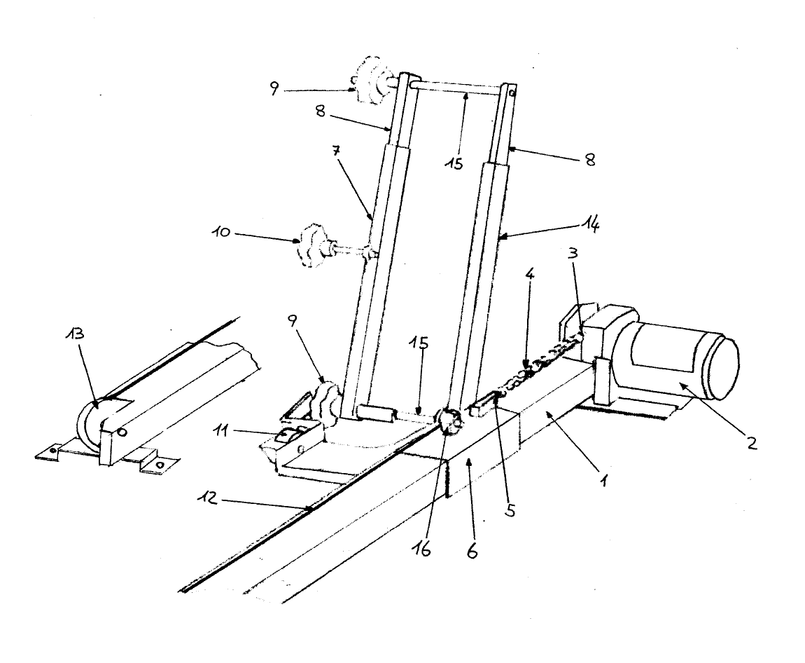

The device is made up of a metal rail (table 2, FIG. 1) which guides the movement of a carriage (table 2, FIG. 6). The said carriage is made up of one fixed bar and one mobile bar (respectively table 2, FIGS. 14 and 7) which is compressed by two knobs (table 2, FIG. 9) screwed onto a threaded bar a (table 2, FIG. 15) and a roller to keep the carriage flat.

Said bars (fixed and mobile) are tubular and inside them are fitted another two sliding bars (table 2, FIG. 8) used to block the wheel of the vehicle, depending on its size.

A small threaded bar is placed along the mobile bar; this is tightened by a knob (table 2, FIG. 10) to ensure that the blocked wheel does not roll backwards.

The forward/backwards movement is operated by an electrically driven 12 V engine (table 2, FIG. 2) which is fixed at the end of the rail and operates a chain or a belt (table 2, FIG. 4) by means of a pinion (table 2, FIG. 3). The chain or belt is in turn linked to a steel cable that runs inside the sliding bar. Said chain or belt is fixed onto the back of the carriage with a linkage, while the steel cable which runs through a pulley (table 2, FIG. 13) is fixed onto the front part with a clamp (table 2, FIG. 16).

### How it Works

The loading or unloading of motorcycles with two or more wheels on various types of vehicles, for example camper vans, trucks, vans, pick-up trucks is carried out as follows: once the motorcycle has been positioned onto the access ramp of the truck or van, the front wheel is placed into the clamp of the device (table 2, FIG. 6) and is blocked with the two knobs (table 2, FIG. 9); a third safety knob screw is then tightened (table 2, FIG. 10). The vehicle is now blocked and well-balanced. At this point, the engine of the device which is activated by an “up” switch, turns a pinion which pulls a chain or belt linked to a steel cable; the pinion itself rewinds the amount of travel required when the process is reverted by the “down” switch which turns the pinion in the opposite direction.

1. Device for entry and exit of motorcycles with two or more wheels consisting of a metal guiding rail (table 2, FIG. 1) which guides a sliding clamp carriage (table 2, FIG. 6) with two bars that block the front wheel of the motorcycle to be loaded and with an engine which operates a pinion, charactenzed in thaat said pinion is equipped with a chain or belt (table 2, FIG. 4) which, in turn is linked to a steel cable (table 2, FIG. 12) that runs inside the sliding bar attached to the back part to the clamp carriage by a linkage. Said steel cable, slides through a pulley (table 2, FIG. 13) and is fixed onto the front part with a clamp (table 2, FIG. 16).

2. Device for loading and unloading motorcycles with two or more wheels as in previous claim 1) characterized by a supporting structure fitted with a clamp-carriage that runs along the structure itself. Said structure also houses the chain or belt and the cable joined together.

3. Device for loading and unloading motorcycles with two or more wheels as in previous claims 1), 2) characterized by an engine fitted onto the end of the sliding guiding rail, which, by means of a pinion (table 2, FIG. 3) moves a chain or belt (table 2, FIG. 4). Said chain is connected with a steel cable (table 2, FIG. 12) placed inside the sliding rail.

4. Clamp carriage as in previous claims 1), 2), 4) characterized by a fixed bar (table 2, FIG. 14) and a moving bar (table 2, FIG. 7) Said moving bar is compressed by means of two knobs (table 2, FIG. 9) which screw onto a threaded bar (table 2, FIG. 15);

5. Clamp carriage as in previous claims 1), 2),4),5) characterized by a fixed bar (table 2, FIG. 14) and a moving bar (table 2, FIG. 7) inside which there are other two sliding bars (table 2, FIG. 8) used to block the wheel depending on its size.

6. Clamp carriage as in previous claims 1), 2), 4), 5), 6) characterized by a roller which ensures that the sliding clamp remains flat while moving along the supporting rail of the device.
